(19) United States
(12) Patent Application Publication
(10) Pub. No.: US 2015/0206275 A1
(43) Pub. Date: Jul. 23, 2015

(54) MULTI-GRAPHICS PROCESSING UNIT (GPU)-BASED MULTI-PHYSICS SIMULATION METHOD AND APPARATUS

(71) Applicant: Electronics and Telecommunications Research Institute, Daejeon (KR)

(72) Inventors: Seung Hyup SHIN, Daejeon (KR); Il Kwon JEONG, Daejeon (KR)

(21) Appl. No.: 14/601,164

(22) Filed: Jan. 20, 2015

(30) Foreign Application Priority Data
Jan. 20, 2014 (KR) 10-2014-0006896

(51) Int. Cl. G06T 1/20

(52) U.S. Cl. CPC G06T 1/20

(57) ABSTRACT

A multi-graphics processing unit (GPU)-based multi-physics simulation method and apparatus. In an exemplary embodiment, the multi-physics simulation method includes: determining a domain dividing manner by performing mock simulation; performing main simulation by using multi-graphic processing units (GPU) by targeting a plurality of physics model data on domains divided in the determined domain dividing manner; and sharing a result of the main simulation.

### CROSS-REFERENCE TO RELATED APPLICATION(S)

This application claims the benefit under 35 U.S.C. §119(a) of Korean Patent Application No. 10-2014-0006896, filed on Jan. 20, 2014, in the Korean Intellectual Property Office, the entire disclosure of which is incorporated herein by reference for all purposes.

### BACKGROUND

1. Field

The following description relates to a computer graphics processing technology, and more specifically, to a computer graphics-related accelerating technology.

2. Description of the Related Art

As a computer graphic technology is being developed, a demand for creating realistic scenes is increasing. The greatest difficulties in producing various realistic and natural expressions are numerous computation quantities required in processing complicated movements of natural objects. A method of processing a manner is actively being studied in various fields as the manner for, based on a proper physical model, simulating interactions between numerous elements is widely being used to realistically express water, fire, and brokenness, etc., which depended on either a noise function superposition of a simple form or an expression ability by a skilled animator.

From a hardware point of view, there is a trend in physical simulation for image production, which is performed based on a Graphics Processing Unit (GPU) with computational performance tens to hundreds of times bigger compared to the Central Processing Unit (CPU). Particularly, a large-scale simulation system based on multi-GPUs or GPU clusters is recently being studied to further increase a computation speed and a scale in processing scenes.

For effectively simulating various physical formations, a data structure and physical model of a proper form is used in general. For example, in expressing quiet water of a wide area, a method of defining water simulation data in a grid data structure and updating the water simulation data by using a finite difference method (FDM) is used. In contrast, in a case where a spray of water violently moving is generated, a manner of simulating a number of particles and the interactions between them is widely used.

### SUMMARY

A multi-graphics processing unit (GPU)-based multi-physics simulation method and apparatus that simultaneously supports interactions between various physical models based on the multi GPU is provided.

In one general aspect, a multi-physics simulation method includes: determining a domain dividing manner by performing mock simulation; performing main simulation by using multi-graphic processing units (GPU) by targeting a plurality of physics model data on domains divided in the determined domain dividing manner; and sharing a result of the main simulation.

In another general aspect, a multi-physics simulation apparatus includes: a first GPU to simulate first physics model data; and a second GPU to, when performing the simulation in the first GPU, simultaneously simulate second physics model data whose simulation manner is different from the first physics model data, and share a simulation result with the first GPU.

Other features and aspects may be apparent from the following detailed description, the drawings, and the claims.

### BRIEF DESCRIPTION OF THE DRAWINGS

FIG. 1 is a diagram illustrating a bus of a graphics processing unit (GPU) based on Peripheral Component Interconnect Express (PCIe)/I/O hub (IOH) according to an exemplary embodiment.

FIG. 2 is a flowchart illustrating a multi-physics simulation method according to an exemplary embodiment.

FIG. 3 is a diagram illustrating a domain dividing manner according to a first exemplary embodiment.

FIG. 4 is a diagram illustrating a domain dividing manner according to a second exemplary embodiment.

FIG. 5 is an embodiment of the present invention may be implemented in a computer system.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

First, terms are defined as follows:

Grid simulation: a manner of updating a speed, density, etc., of fluids by using interactions between adjacent grid points after dividing space into small grids and defining the density, speed, etc., of the fluids in each grid point; used often in simulating quiet ocean waves or smoke.

Smoothed particle hydrodynamics (SPH): a particle-based simulation manner of sampling a physics quantity of a random point from the particle, in which quality and density, etc. are defined, and computing power transferred between particles; usually used in simulating a rigid body, such as wild active waters or a complex form.

A simulation time step: a numeral simulation repeats a process of computing a step after a short period of time on the basis of a simulation state at a predetermined time, wherein the time gap between simulation steps is defined as a time step.

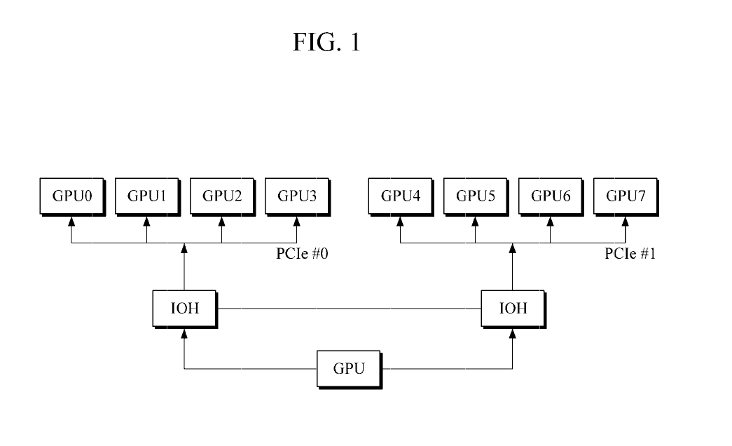

FIG. 1 is a diagram illustrating a bus of a graphics processing unit (GPU) based on Peripheral Component Interconnect Express (PCIe)/I/O hub (IOH) according to an exemplary embodiment.

Referring to FIG. 1, a multi-physics simulation apparatus (hereinafter referred to as ‘a simulation apparatus’) according to the present disclosure targets a PCIe bus-based workstation system, which is one of the forms widely used in an image production studio. FIG. 1 is a structure diagram of a bus connection between a graphics processing unit (hereinafter referred to as GPU) and a central processing unit (hereinafter referred to as CPU), and the following description is based on this structure diagram. However, the relevant structure is only an example for understanding the present disclosure, and the structure and form of the bus may be changed in various forms.

A plurality of GPUs is used in the physics simulation in the present disclosure, and a plurality of physics simulation manners is as well. For example, the simulation apparatus as illustrated in FIG. 1 includes seven GPUs (GPU1 to GPU 7). Here, GPU0 is assumed as a GPU for displaying in real time for checking a simulation result. Various physics simulation manners include a grid-based fluid simulation manner and a particle-based physics simulation manner.

Referring to FIG. 1, a maximum of four GPUs according to an exemplary embodiment may be bound in a PCIe bus under one IOH, and the four GPUs may transmit data through the PCIE bus at a fast speed (Device-to-device copy: D2D). In contrast, communications between GPUs under another IOH are performed through a CPU, which causes a decline in speed more than multiple times (Device-to-host copy: D2H).

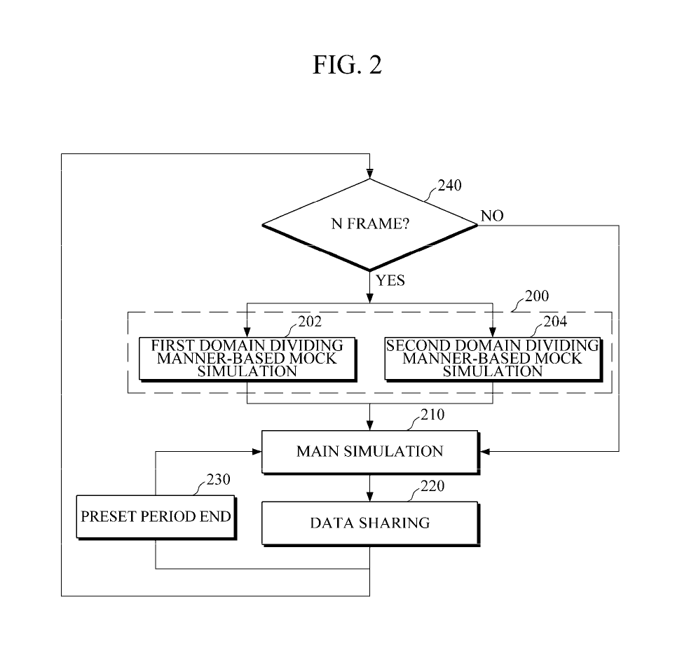

FIG. 2 is a flowchart illustrating a multi-physics simulation method according to an exemplary embodiment.

Referring to FIG. 2, a simulation apparatus performs mock simulation 200 prior to main simulation 210 and determines a domain dividing manner for multi-physics simulation. In a case of a single simulation performance using multi-GPUs, the simulation apparatus divides the domain, which is computation space, into as much as the number of GPUs. Then, after computing as many changes as a simulation time step for each domain, the simulation apparatus exchanges the simulation results between spatially adjacent domains. However, in a case of performing not the single simulation but the multiple simulation, the simulation data affecting each other is required to be shared because the interactions between the simulation may be computed. Thus, the simulation time generated in a GPU, and data copying time for sharing the simulation result all affect the entire simulation performances. Such time is greatly affected depending on how the simulation space for each GPU is divided.

In an exemplary embodiment, a first domain dividing manner and a second domain dividing manner are suggested. The first domain dividing manner-based mock simulation 202 and the second domain dividing manner-based mock simulation 204 are performed at the same time, and based on the performance result, any one of the domain dividing manners is selected. There is no absolute priority among the domain dividing manners, and a big difference in efficiency is generated according to a simulation scene. In addition, the efficiency differs for each domain dividing manner according to the data distribution while the same simulation is in progress. For such an application, the present disclosure determines an optimum domain dividing manner through the mock simulation 200 prior to the main simulation 210.

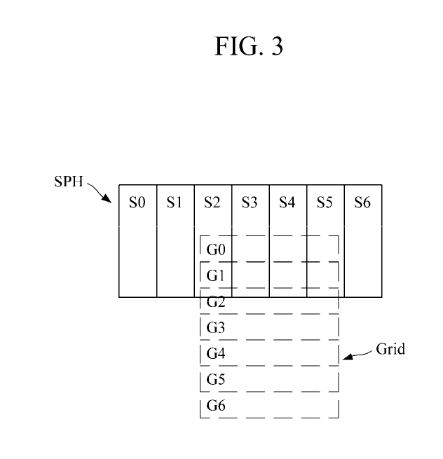

The first domain dividing manner is to divide a domain according to each simulation manner. That is, the first domain dividing manner is a separately divided form of a domain where physics model data of a particle simulation manner is formed, and a domain where physics model data of a grid simulation manner is formed. An exemplary embodiment related to the first domain dividing manner is described later with reference to FIG. 3.

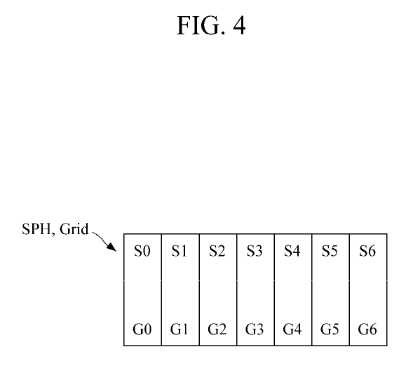

The second domain dividing manner is to include, in one domain, physics model data of each simulation manner and divide the physics model data equally between the domains. In other words, the second domain dividing manner is a manner where the physics model data of a particle simulation manner and the physics model data of a grid simulation manner are included in one domain. An exemplary embodiment related to the second domain dividing manner is described later with reference to FIG. 4.

The mock simulation 200 according to an exemplary embodiment is low resolution simulation, and the main simulation 210 is high resolution simulation. The simulation apparatus may repeatedly perform the mock simulation 200 as many times as set in advance. In an exemplary embodiment, the simulation apparatus may sample some of the domain and perform the mock simulation 202 and 204 according to each simulation manner by targeting the sampled domain to determine a domain dividing manner. Determining the domain dividing manner may be performed in a controller, which may be a CPU that manages a GPU.

In an exemplary embodiment, the simulation apparatus performs mock simulation according to each domain dividing manner in 200, and selects one of the domain dividing manners by using the mock simulation result. For example, as illustrated in FIG. 1, by targeting an n-th frame, the simulation apparatus simultaneously performs mock simulation 202 in a case of domain division according to each simulation manner, and mock simulation 204 in a case of equal division between the domains. Then, based on the mock simulation result, the simulation apparatus selects the most effective domain dividing manner. The simulation apparatus according to an exemplary embodiment finally selects the manner with the quickest simulation speed among the domain dividing manners. However, the exemplary embodiment is only one example of selecting the domain dividing manner, and the simulation apparatus may select the domain dividing manner, putting weight on another parameter other than the speed.

Then, the simulation apparatus divides domains in the domain dividing manner that has been determined through the mock simulation 200, and performs main simulation with multi-GPUs by targeting a plurality of physics model data on the divided domains in 210. The simulation apparatus performs particle simulation and grid simulation at the same time through the main simulation 210 by targeting the plurality of physics model data. At this time, a GPU for each domain may compute as many changes as a simulation time step.

Then, the simulation apparatus shares the main simulation result in 220. At this time, the simulation apparatus may share physics model data between domains and between simulation manners. After the main simulation result, if the preset time passes after the sharing in 230, the simulation apparatus may repeatedly perform the main simulation 210.

The above-mentioned simulation process may be performed by a frame unit. That is, the mock simulation and the main simulation may be performed by every frame unit, and the domain dividing manner may be updated according to each frame. For example, as illustrated in FIG. 1, after checking an n-th(n is an integer) frame in 240, the mock simulation 200, the main simulation 210, and the data sharing 220 are performed by targeting the n-th frame. The relevant processes 200, 210, and 220 are repeatedly performed with regard to every frame.

FIG. 3 is a diagram illustrating a domain dividing manner according to a first exemplary embodiment.

Referring to FIG. 3, the first domain dividing manner is performing a separate domain division according to each simulation manner. FIG. 3 is an example of particle simulation and grid simulation being performed at the same time and interacting with each other. In this example, it is assumed that particle simulation data is distributed in domain space including S0˜S6, and grid simulation data is distributed in domain space including G0˜G6. It is assumed that S0˜S6 is divided so as to each include the same number of particles, and that G0˜G6 is divided so as to each have the same volume. Here, in view of each simulation manner, computation quantities in each GPU are almost the same. That is, C_{S0}= . . . =C_{S6}, and C_{G0}= . . . =C_{G6}. For data sharing after a simulation time step, the data copy is generated as follows:

From S2→G0, G1, G2

From S3→G0, G1, G2

From S4→G0, G1, G2

From S5→G0, G1, G2

From G0→S2, S3, S4, S5

From G1→S2, S3, S4, S5

From G2→S2, S3, S4, S5

Likewise, in a case of domain division according to each simulation manner, optimum resources distribution occurs when computing the GPU, whereas it is possible that efficiency may relatively decline when sharing the computation result.

FIG. 4 is a diagram illustrating a domain dividing manner according to a second exemplary embodiment.

Referring to FIG. 4, the second domain dividing manner is computing all the simulation according to only one domain division. FIG. 4 is an example of entire space, divided into the same volume, including all physics data of particle simulation and grid simulation. In view of each simulation manner, the space where the relevant simulation is actually performed is only a part of the entire space so the difference of the computation quantity is big for each of the divided space, and some GPUs may have high possibilities of not having any data to be computed and the computation quantity to be concentrated in a certain GPU. However, after the simulation, only the data in the same divided space is given and taken for sharing particle-based physics data and grid-based physics data, thus increasing the efficiency. A method of sharing data between domains is as follows:

From S0→G0, from S1→G1, from S2→G2, from S3→G3, from S4→G4, from S5→G5, from S6→G6, from G0→S0, from G1→S1, from G2→S2, from G3→S3, from G4→S4, from G5→S5, and from G6→S6.

In an exemplary embodiment, as various physics simulations are performed using multi-GPUs, the simulation may be accelerated. Particularly, interaction between various physics simulation models may be efficiently computed in multi-GPUs. Furthermore, as mock simulation is performed prior to a main simulation, a domain dividing manner for the optimum simulation may be found.

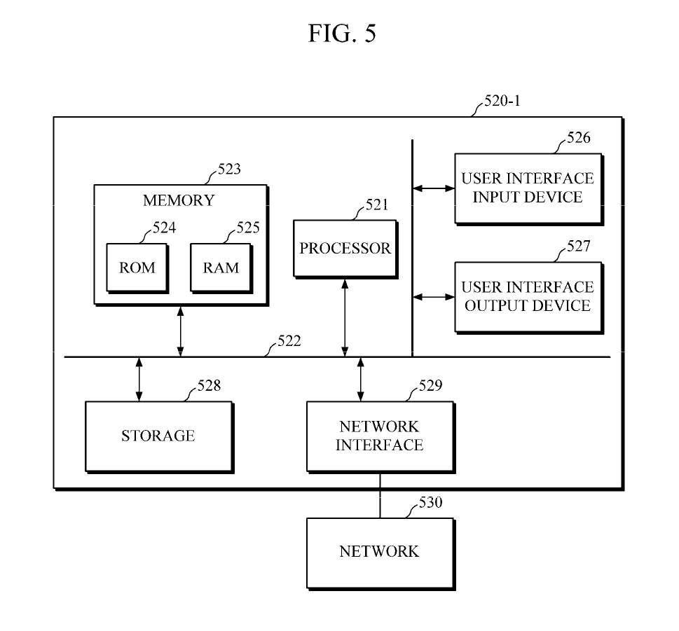

An embodiment of the present invention may be implemented in a computer system, e.g., as a computer readable medium. As shown in in FIG. 5, a computer system 520-1 may include one or more of a processor 521, a memory 523, a user input device 526, a user output device 527, and a storage 528, each of which communicates through a bus 522. The computer system 520-1 may also include a network interface 529 that is coupled to a network 530. The processor 521 may be a central processing unit (CPU) or a semiconductor device that executes processing instructions stored in the memory 523 and/or the storage 528. The memory 523 and the storage 528 may include various forms of volatile or non-volatile storage media. For example, the memory may include a read-only memory (ROM) 524 and a random access memory (RAM) 525.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A multi-physics simulation method, comprising:
determining a domain dividing manner by performing mock simulation;
performing main simulation by using multi-graphic processing units (GPU) by targeting a plurality of physics model data on domains divided in the determined domain dividing manner; and
sharing a result of the main simulation.

2. The multi-physics simulation method of claim 1, wherein the mock simulation is low resolution simulation compared to the main simulation which is high resolution simulation compared to the mock simulation.

3. The multi-physics simulation method of claim 1, wherein the determining of the domain dividing manner comprises:
performing the mock simulation for each preset domain dividing manner; and
selecting one of the domain dividing manners by using a result of the mock simulation.

4. The multi-physics simulation method of claim 3, wherein the performing of the mock simulation comprises repeatedly performing as many times as set in advance.

5. The multi-physics simulation method, wherein the selecting of one of the domain dividing manners comprises:
lastly selecting a manner with a shortened simulation speed among the domain dividing manners based on the result of the mock simulation for each domain dividing manner.

6. The multi-physics simulation method of claim 1, wherein the determining of the domain dividing manner comprises sampling the domain, performing the mock simulation by targeting the sampled domain, and determining the domain dividing manner.

7. The multi-physics simulation method of claim 1, wherein the determining of the domain dividing manner comprises determining, as the domain dividing manner, a manner of dividing the domain according to each simulation manner.

8. The multi-physics simulation method of claim 7, wherein the manner of dividing the domain according to each simulation manner comprises separately dividing a domain where physics model data of a particle simulation manner is formed and a domain where physics model data of a grid simulation manner is formed, wherein each of the domain of the particle simulation manner includes a same number of particles, and wherein each of the domain of the grid simulation manner includes a same volume.

9. The multi-physics simulation method of claim 1, wherein the determining of the domain dividing manner comprises determining, as the domain dividing manner, a manner of including physics model data of each simulation manner in one domain and equally dividing the included physics model data between the domains.

10. The multi-physics simulation method of claim 9, wherein the manner of equally dividing the included physics model data between the domains includes, in one domain, the physics model data of the particle simulation manner and the physics model data of the grid simulation manner, wherein each of the domains has a same volume.

11. The multi-physics simulation method of claim 1, wherein the performing of the main simulation comprises simultaneously performing particle simulation and grid simulation by targeting the plurality of physics model data.

12. The multi-physics simulation method of claim 1, wherein the performing of the main simulation comprises computing as many changes as a simulation time step by each GPU related to each domain by targeting each domain.

13. The multi-physics simulation method of claim 1, wherein the performing of the main simulation comprises performing, by the GPU for each domain, the main simulation as having a same computation quantity.

14. The multi-physics simulation method of claim 1, wherein the sharing of the result of the main simulation comprises sharing the plurality of physics model data between the domains and between the simulation manners.

15. The multi-physics simulation method of claim 14, wherein the sharing of the result of the main simulation comprises:
in a case in which physics model data of each of the simulation manners is equally divided into one domain, sharing the physics model data for each of the domains between the simulation manners included in the domains.

16. The multi-physics simulation method of claim 1, comprising:
performing the mock simulation and the main simulation by a frame unit, and updating the domain dividing manner according to each frame.

17. A multi-physics simulation apparatus, comprising:
a first GPU configured to simulate first physics model data; and
a second GPU configured to, when performing the simulation in the first GPU, simultaneously simulate second physics model data whose simulation manner is different from the first physics model data, and share a simulation result with the first GPU.

18. The multi-physics simulation apparatus of claim 17, wherein the first physics model data is data for particle simulation, and the second physics model data is data for grid simulation, wherein the data for the particle simulation and the data for the grid simulation are separately divided into a plurality of domains and are included in or divided into a same domain.

19. The multi-physics simulation apparatus of claim 17, wherein the first GPU and the second GPU are connected through an identical bus or different buses.

20. The multi-physics simulation apparatus of claim 17, further comprising:
a controller configured to, in response to performing, by the first GPU and the second GPU, mock simulation by targeting a plurality of physics model data, determine a domain dividing manner by using a result of the mock simulation, wherein the first GPU and the second GPU perform main simulation of the plurality of physics model data within domains divided through the domain dividing manner determined by the controller.
